(19) United States
(12) Patent Application Publication
(10) Pub. No.: US 2020/0035183 A1
(43) Pub. Date: Jan. 30, 2020

(54) ARRAY SUBSTRATE, DISPLAY PANEL AND DISPLAY DEVICE

(71) Applicants: Chengdu BOE Optoelectronics Technology Co., Ltd., Chengdu (CN); BOE Technology Group Co., Ltd., Beijing (CN)

(72) Inventors: Tao HOU, Beijing (CN); Junping BAO, Beijing (CN); Xinghua LI, Beijing (CN)

(73) Assignees: Chengdu BOE Optoelectronics Technology Co., Ltd.; BOE Technology Group Co., Ltd.

(21) Appl. No.: 16/399,260

(22) Filed: Apr. 30, 2019

(30) Foreign Application Priority Data
Jul. 30, 2018 (CN) 201810854321.6

(51) Int. Cl. G09G 3/36

(52) U.S. Cl. CPC G09G 3/3677

(57) ABSTRACT

An array substrate, a display panel and a display device are provided. In the array substrate, at least one first thin film transistor and at least one second thin film transistor are arranged in each sub-pixel element to be electrically connected with a pixel electrode, and gates of the plurality of the thin film transistors are connected with different gate lines, that is, the plurality of the thin film transistors in the same sub-pixel element are arranged in parallel, thus the sub-pixel element is charged by inputting a scan signal concurrently to the plurality of gate lines to turn on the plurality of thin film transistors concurrently, and the data line outputs a data voltage to the pixel electrode.

### CROSS-REFERENCES TO RELATED APPLICATIONS

This application claims priority to Chinese patent application No. 201810854321.6 filed on Jul. 30, 2018, which is incorporated herein by reference in its entirety.

### FIELD

The present disclosure relates to the field of display technologies, and particularly to an array substrate, a display panel and a display device.

### BACKGROUND

A Liquid Crystal Display (LCD) has been widely concerned by the industry due to its small volume, low power consumption, no radiation, and other advantages.

Pixels in the LCD are driven by applying a scan signal to gate lines to turn on thin film transistors, data lines outputting data voltage to pixel electrodes to charge the pixels, and turning off the thin film transistors after the pixels are charged, to maintain the voltage.

### SUMMARY

In one aspect, an embodiment of the disclosure provides an array substrate. The array substrate includes: a plurality of first gate lines, a plurality of second gate lines, a plurality of data lines, and a plurality of sub-pixel elements in an array, wherein each row of the sub-pixel elements is connected with one of the first gate lines and one of the second gate lines, and each column of the sub-pixel elements is connected with one of the data lines; and each of the sub-pixel elements includes: a pixel electrode, at least one first thin film transistor, and at least one second thin film transistor; and in each sub-pixel element in each row, the first thin film transistor has a gate connected with the first gate line corresponding to the row, a first electrode connected with the corresponding data line, and a second electrode connected with the the pixel electrode; and the second thin film transistor has a gate connected with the second gate line corresponding to the row, a first electrode connected with the corresponding data line, and a second electrode connected with the pixel electrode.

In a possible implementation, in the array substrate above according to the embodiment of the disclosure, the first gate line and the second gate line, and the first thin film transistor and the second thin film transistor are configured to improve charging efficiency of the sub-pixel elements.

In a possible implementation, in the array substrate above according to the embodiment of the disclosure, the first thin film transistor and the second thin film transistor are opposite types of thin film transistors.

In a possible implementation, in the array substrate above according to the embodiment of the disclosure, the first thin film transistor is an N-type thin film transistor, and the second thin film transistor is a P-type thin film transistor; or the first thin film transistor is a P-type thin film transistor, and the second thin film transistor is an N-type thin film transistor.

In a possible implementation, in the array substrate above according to the embodiment of the disclosure, the array substrate further includes an inverter connected between the first gate line and the second gate line corresponding to each row of sub-pixel elements.

In a possible implementation, in the array substrate above according to the embodiment of the disclosure, the array substrate further includes a gate driver circuit connected with the first gate line, wherein the gate driver circuit is configured to output a signal to the first gate line, the inverter inverts the signal on the first gate line and outputs to the second gate line, to control the first thin film transistors and the second thin film transistors to be turned on concurrently.

In a possible implementation, in the array substrate above according to the embodiment of the disclosure, the array substrate further includes a gate driver circuit connected with the second gate line, wherein the gate driver circuit is configured to output a signal to the second gate line, the inverter inverts the signal on the second gate line and outputs to the first gate line, to control the first thin film transistors and the second thin film transistors to be turned on concurrently.

In a possible implementation, in the array substrate above according to the embodiment of the disclosure, the array substrate further includes: a first gate driver circuit connected with the first gate lines, and a second gate driver circuit connected with the second gate lines, wherein for the first gate line and the second gate line corresponding to a same row of sub-pixel elements, a signal output by the first gate driver circuit to the first gate line is opposite in phase to a signal output by the second gate driver circuit to the second gate line at a same instance of time.

In a possible implementation, in the array substrate above according to the embodiment of the disclosure, the array substrate further includes a base substrate. The first gate line is located between two adjacent rows of sub-pixel elements, and an orthographic projection of the second gate line on the base substrate overlaps with orthographic projections of the pixel electrodes on the base substrate.

In a possible implementation, in the array substrate above according to the embodiment of the disclosure, for each row of sub-pixel elements, the first thin film transistors and the second thin film transistors are located between the first gate line and the second gate line.

In a possible implementation, in the array substrate above according to the embodiment of the disclosure, the first thin film transistors and the second thin film transistors are arranged in parallel in the column direction.

In a possible implementation, in the array substrate above according to the embodiment of the disclosure, the array substrate further includes a base substrate. An orthographic projection of each of the first gates and second gate lines on the base substrate has no overlapping with orthographic projections of the pixel electrodes on the base substrate.

In a possible implementation, in the array substrate above according to the embodiment of the disclosure, for each row of sub-pixel elements, the first gate line and the second gate line are located on the same side of the row of sub-pixel elements.

In a possible implementation, in the array substrate above according to the embodiment of the disclosure, the first gate line and the second gate line are arranged adjacent to each other, and the first thin film transistors and the second thin film transistors are located on the sides of the first gate line and the second gate line toward to the pixel electrodes, and between the first gate line, the second gate line and the pixel electrodes.

In a possible implementation, in the array substrate above according to the embodiment of the disclosure, the first thin film transistors and the second thin film transistors are arranged in parallel in the row direction.

In a possible implementation, in the array substrate above according to the embodiment of the disclosure, for each row of sub-pixel elements, the first gate line and the second gate line are located respectively on two sides of the row of sub-pixel elements.

In a possible implementation, in the array substrate above according to the embodiment of the disclosure, the first thin film transistor is located on a side of the pixel electrode proximate to the first gate line, and the second thin film transistor is located on a side of the pixel electrode proximate to the second gate line.

In another aspect, an embodiment of the disclosure further provides a display panel including the array substrate above according to the embodiment of the disclosure.

In another aspect, an embodiment of the disclosure further provides a display device including the display panel above according to the embodiment of the disclosure.

### BRIEF DESCRIPTION OF THE DRAWINGS

FIG. 1 is a schematic structural diagram of an array substrate;

FIG. 2 is a first schematic structural diagram of an array substrate according to an embodiment of the disclosure;

FIG. 3 is a second schematic structural diagram of the array substrate according to the embodiment of the disclosure;

FIG. 4 is a third schematic structural diagram of the array substrate according to the embodiment of the disclosure;

FIG. 5 is a fourth schematic structural diagram of the array substrate according to the embodiment of the disclosure;

FIG. 6 is a fifth schematic structural diagram of the array substrate according to the embodiment of the disclosure;

FIG. 7 is a sixth schematic structural diagram of the array substrate according to the embodiment of the disclosure;

FIG. 8 is a schematic structural diagram of an inverter according to an embodiment of the disclosure; and

FIG. 9 is a timing diagram of voltage on a first gate line and a second gate line according to an embodiment of the disclosure.

### DETAILED DESCRIPTION

In order to make the objects, technical solutions, and advantages of the disclosure more apparent, specific implementations of the array substrate, the display panel, and the display device according to the embodiments of the disclosure will be described below in details with reference to the drawings.

The thicknesses and shapes of respective layers in the drawings will not be reflect any real proportion of the array substrate, but are only intended to illustrate the content of the disclosure.

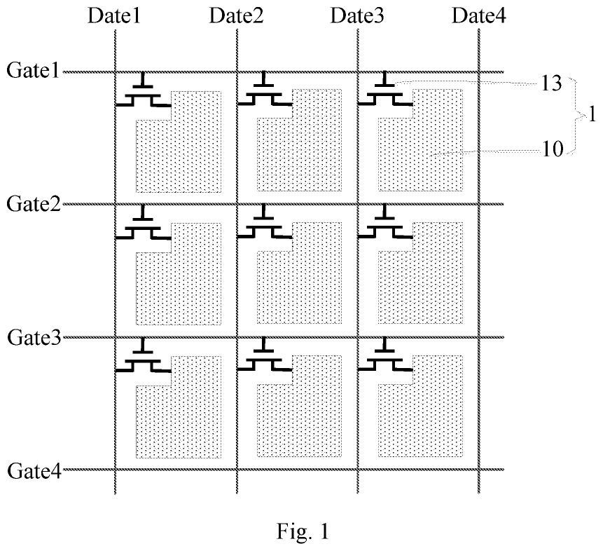

An array substrate in the related art as illustrated in FIG. 1 includes: a plurality of gate lines (Gate1, Gate2, Gate3, . . . ) and data lines (Data1, Data2, Data3, . . . ) intersecting with each other and insulated from each other, and a plurality of sub-pixel elements 1, arranged in an array, defined by the intersecting gate lines (Gate1, Gate2, Gate3, . . . ) and data lines (Data1, Data2, Data3, . . . ). Each sub-pixel element 1 includes a pixel electrode 10 and a thin film transistor 13, and the thin film transistor 13 has a gate connected with a corresponding gate line, a source connected with a corresponding data line, and a drain connected with a corresponding pixel electrode 10; and all the thin film transistors 13 in FIG. 1 are N-type transistors, a scan signal is applied to the gate lines to turn on the thin film transistors 13, data lines output data voltage to the pixel electrodes to charge the pixels, and the thin film transistors 13 are turned off after the pixels are charged, to maintain the voltage. However in the related art, each pixel electrode 10 is charged through one thin film transistor 13, so the pixel electrode may be charged for a longer time, charging efficiency is lower, thus hindering the resolution from being improved.

Embodiments of the disclosure provide an array substrate, a display panel, and a display device so as to improve the charging efficiency of the pixels.

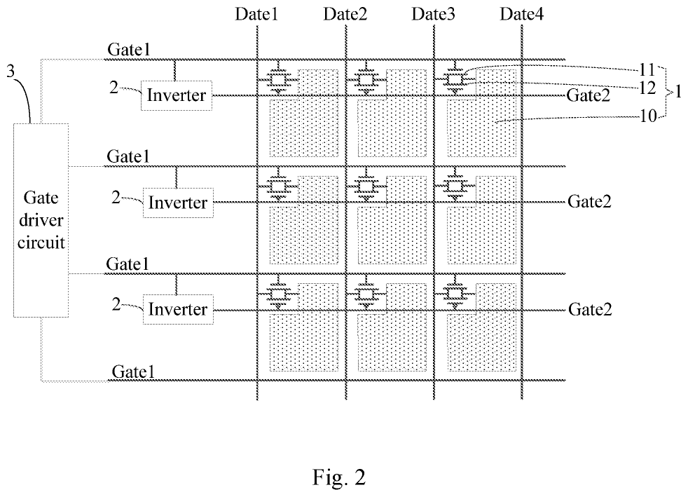

An embodiment of the disclosure provides an array substrate. As illustrated in FIG. 2 to FIG. 7, the array substrate includes a plurality of first gate lines Gate1, a plurality of second gate lines Gate2, a plurality of data lines (Data1, Data2, Data 3, . . . ), and a plurality of sub-pixel elements 1 in an array; and each row of sub-pixel elements 1 is connected with one first gate line Gate1 and one second gate line Gate2, and each column of sub-pixel elements 1 is connected with one data line (for example, the first column of sub-pixel elements 1 is connected with the data line Data1, the second column of sub-pixel elements 1 is connected with the data line Data2, the third column of sub-pixel elements 1 is connected with the data line Data3, . . . ).

Each sub-pixel element 1 includes: a pixel electrode 10, at least one first thin film transistor 11, and at least one second thin film transistor 12 (for example, each sub-pixel element 1 includes one first thin film transistor 11 and one second thin film transistor 12 throughout the disclosure); and in each sub-pixel element 1 in each row, the first thin film transistor 11 has a gate connected with the first gate line Gate1 corresponding to the row, a first electrode connected with the corresponding data line, and a second electrode connected with the corresponding pixel electrode 10; and the second thin film transistor 12 has a gate connected with the second gate line Gate2 corresponding to the row, a first electrode connected with the corresponding data line, and a second electrode connected with the corresponding pixel electrode 10.

In the array substrate according to the embodiment of the disclosure, at least one first thin film transistor and at least one second thin film transistor are arranged in each sub-pixel element to be electrically connected with a pixel electrode, and gates of the respective thin film transistors are connected with different gate lines, that is, the respective thin film transistors in the same sub-pixel element are arranged in parallel connection, so that the sub-pixel element is charged by inputting a scan signal concurrently to the respective gate lines to turn on the respective thin film transistors, and data lines outputting data voltage to the pixel electrode so that the charging efficiency of the pixel electrode can be improved by charging the same pixel electrode concurrently through the at least two thin film transistors.

In a specific implementation, two adjacent sub-pixel elements are charged respectively to positive and negative voltage, and since an N-type thin film transistor is charged to negative voltage more quickly than positive voltage, different charging efficiencies for a pixel electrode charged to the positive voltage and a pixel electrode charged to the negative voltage in the same row concurrently, thus resulting in a difference in luminance between the sub-pixel elements in the same row. Accordingly in the array substrate above according to the embodiment of the disclosure, the first thin film transistor and the second thin film transistor are opposite types of thin film transistors. For example, the first thin film transistor is an N-type thin film transistor, and the second thin film transistor is a P-type thin film transistor; or the first thin film transistor is a P-type thin film transistor, and the second thin film transistor is an N-type thin film transistor. As illustrated in FIG. 1 to FIG. 7, the first thin film transistor 11 is an N-type thin film transistor, and the second thin film transistor 12 is a P-type thin film transistor throughout this context, for example, but the same principle as when the first thin film transistor is an N-type thin film transistor, and the second thin film transistor is a P-type thin film transistor will apply when the first thin film transistor is a P-type thin film transistor, and the second thin film transistor is an N-type thin film transistor. Since a P-type thin film transistor is charged to positive voltage more quickly than negative voltage, the pixel electrodes of the respective sub-pixel elements are charged in such a way that a pixel electrode is charged concurrently using two thin film transistors, one of which is an N-type thin film transistor, and the other of which is a P-type thin film transistor, that is, a pixel electrode is charged by a thin film transistor using larger current in each sub-pixel element, so that respective pixel electrodes in the same row can be charged uniformly to thereby address the problem in the related art of the non-uniformity in luminance of the respective pixel electrodes due to different charging efficiencies for the pixel electrodes.

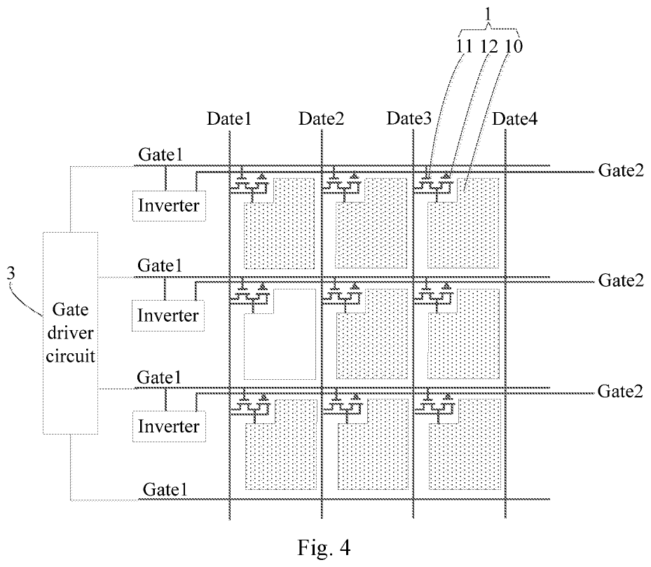

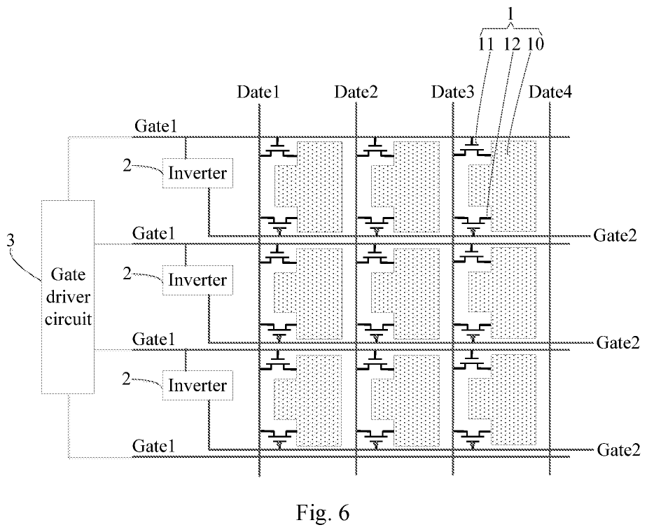

In some embodiments, in the array substrate above according to the embodiment of the disclosure, as illustrated in FIG. 2, FIG. 4, and FIG. 6, the array substrate further includes an inverter 2 connected between the first gate line Gate1 and the second gate line Gate2 corresponding to each row of sub-pixel elements 1. In each row of sub-pixel elements, the gates of the first thin film transistors 11 are connected with the first gate line Gate1 corresponding to the row, and the gates of the second thin film transistors 12 are connected with the second gate line Gate2 corresponding to the row, so when a high-level signal is input to the first gate line Gate1, the high-level signal is inverted by the inverter to a low-level signal to input to the second gate line Gate2. Since the first thin film transistors are N-type thin film transistors, and the second thin film transistors are P-type thin film transistors, the respective first thin film transistors 11 and the respective second thin film transistors 12 in the same row of sub-pixel elements 1 are turned on concurrently, and data lines output data voltages to the pixel electrodes corresponding to the respective sub-pixel elements 1, so each sub-pixel element 1 is charged by a thin film transistor using a larger current so that the respective pixel electrodes in the same row can be charged uniformly to thereby address the problem in the related art of the non-uniformity in luminance of the respective pixel electrodes due to the different charging efficiencies for the respective pixels electrodes.

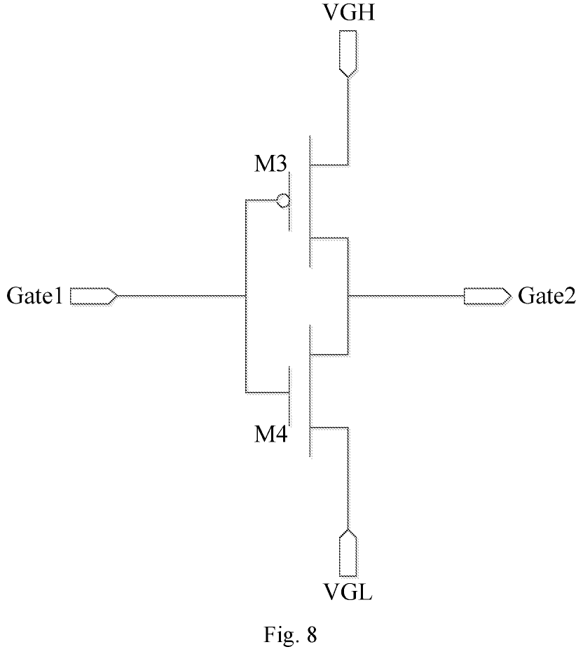

In some embodiments of the disclosure, in the array substrate above, as illustrated in FIG. 8, the inverter 2 can include: a third thin film transistor M3 and a fourth thin film transistor M4, where the third thin film transistor M3 is a P-type thin film transistor, the fourth thin film transistor M4 is an N-type thin film transistor. The gate of the third thin film transistor M3 and the gate of the fourth thin film transistor M4 are connected with the first gate line Gate1, the third thin film transistor M3 has a first electrode connected with a first reference voltage terminal VGH, the fourth thin film transistor M4 has a first electrode connected with a second reference voltage terminal VGL, and the second electrode of the third thin film transistor M3 and the second electrodes of the fourth thin film transistor M4 are connected with the second gate line Gate2; and a signal of the first reference voltage terminal VGH is a high-level signal, and a signal of the second reference voltage terminal VGL is a low-level signal. As illustrated in FIG. 2, FIG. 4, and FIG. 6, when a high-level signal is input by a gate driver circuit 3 to the first gate line Gate1 to turn on the first thin film transistors M11, the third thin film transistors M3 in the inverter is turned off, and the fourth thin film transistor M4 in the inverter is turned on, so the low-level signal of the second reference voltage terminal VGL is output to the second gate line Gate2 through the fourth thin film transistor M4; and since the second thin film transistors 12 connected with the second gate line Gate2 are P-type thin film transistors, the second thin film transistors 12 are turned on by the low-level signal of the second reference voltage terminal VGL, that is, the first thin film transistors 1 and the second thin film transistors 2 are turned on concurrently to charge their corresponding pixel electrodes 10, so the pixel electrode 10 in each sub-pixel element 1 is charged by a thin film transistor using a larger current so that the respective pixel electrodes 10 in the same row can be charged uniformly to thereby address the problem in the related art of the non-uniformity in luminance of the respective pixel electrodes due to due to the different charging efficiencies for the respective pixels electrodes.

In some embodiments of the disclosure, in the array substrate above, as illustrated in

FIG. 2, FIG. 4, and FIG. 6, the array substrate further includes a gate driver circuit 3 connected with the first gate line Gate1 or the second gate line Gate2. When the gate driver circuit 3 is connected with the first gate line Gate1, the gate driver circuit 3 outputs a signal to the first gate line Gate1, the inverter 2 inverts the signal on the first gate line Gate1 and outputs to the second gate line Gate2, to control the first thin film transistors 11 and the second thin film transistors 12 to be turned on concurrently. When the gate driver circuit 3 is connected with the second gate line Gate2, the gate driver circuit 3 outputs a signal to the second gate line Gate2, the inverter 2 inverts the signal on the second gate line Gate2 and then outputs to the first gate line Gate1, to control the first thin film transistors 11 and the second thin film transistors 12 to be turned on concurrently. In the embodiment of the disclosure, the gate driver circuit 3 is connected with the first gate line Gate1, for example, that is, the gate driver circuit 3 inputs a gate driving signal to the gate line of each row to drive the thin film transistors connected with the gate line to be turned on to charge the corresponding pixel electrodes, and the gate driving signal, output by the gate driver circuit 3, to turn on the N-type thin film transistors is inverted by the inverter 2, and then a driving signal can be output to turn on the P-type thin film transistors so that the N-type first thin film transistors 11 and the P-type second thin film transistors 12 can be turned on concurrently to charge their corresponding pixel electrodes, so each sub-pixel element 1 is charged by a thin film transistor using larger current, so that the respective pixel electrodes in the same row can be charged uniformly to thereby address the problem in the related art of a non-uniform luminance of the respective pixel electrodes due to the different charging efficiencies for the respective pixels electrodes. Of course, in a specific implementation, the gate driver circuit 3 can alternatively be connected with the second gate line Gate2, so a gate driving signal output by the gate driver circuit 3 is a signal to turn on the P-type thin film transistors, and the inverter inverts this signal and outputs a driving signal which can turn on the N-type thin film transistors, so that the N-type first thin film transistors 11 and the P-type thin film transistors 12 can be turned on concurrently to charge their corresponding pixel electrodes.

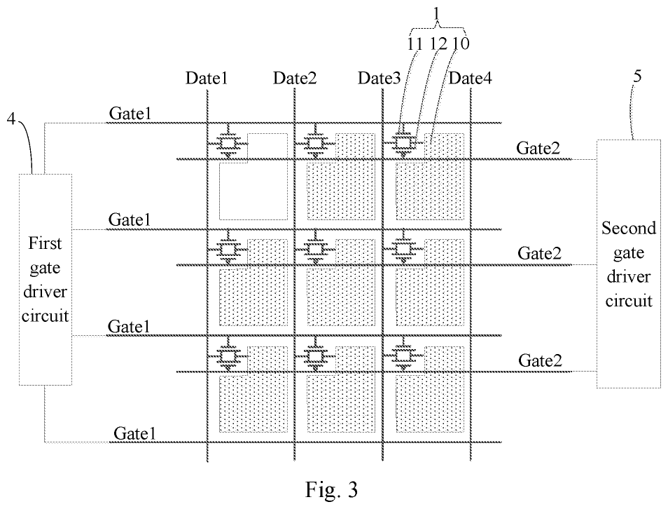

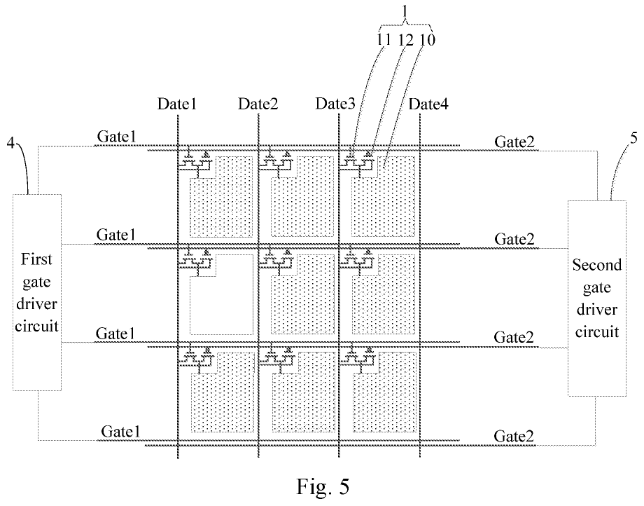

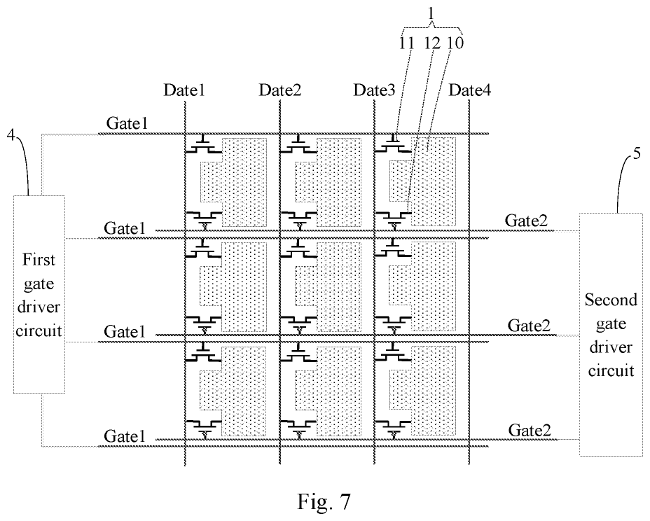

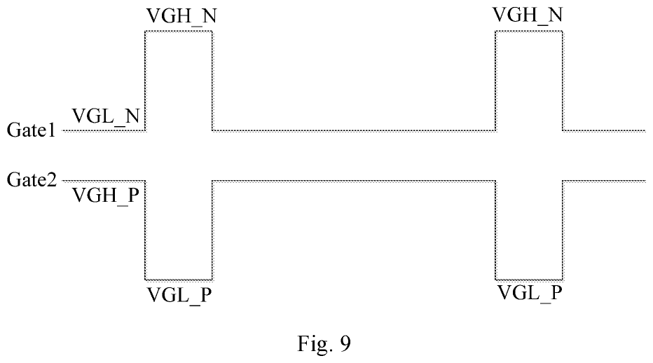

In some embodiments of the disclosure, in the array substrate above, as illustrated in FIG. 3, FIG. 5, and FIG. 7, the array substrate further includes: a first gate driver circuit 4 connected with the first gate lines Gate1, and a second gate driver circuit 5 connected with the second gate lines Gate2. For the first gate line Gate1 and the second gate line Gate2 corresponding to the same row of sub-pixel elements, a signal output by the first gate driver circuit 4 to the first gate line Gate1 is opposite in phase to a signal output by the second gate driver circuit 5 to the second gate line Gate2 at the same instance of time. FIG. 9 illustrates a timing diagram of voltage signals output by the first gate driver circuit 4 and the second gate driver circuit 5 to the first gate line Gate1 and the second gate line Gate2 corresponding to the same row of sub-pixel elements at the same instance of time, where the first gate line Gate1 is connected with the N-type thin film transistors, the second gate line Gate2 is connected with the P-type thin film transistors, a low-level signal corresponding to the first gate line Gate1 is VGL_N, a high-level signal corresponding to the first gate line Gate1 is VGH_N, a low-level signal corresponding to the second gate line Gate2 is VGL_P, and a high-level signal corresponding to the second gate line Gate2 is VGH_P. In each row of sub-pixel elements 1, in the embodiment of the disclosure, the first gate driver circuit 4 outputs the signal to the first gate line Gate1 to drive the first thin film transistors 11 to be turned on, and the second gate driver circuit 5 outputs the signal to the second gate line Gate2 to drive the second thin film transistors 12 to be turned on, so the N-type first thin film transistors 11 and the P-type second thin film transistors 12 can be turned on concurrently to charge their corresponding pixel electrodes 10, so the pixel electrode 10 in each sub-pixel element 1 is charged by a thin film transistor using larger current so that the respective pixel electrodes in the same row can be charged uniformly to thereby address the problem in the related art of the non-uniformity in luminance of the respective pixel electrodes due to the different charging efficiencies for the respective pixels electrodes.

In some embodiments of the disclosure, in the array substrate above, as illustrated in FIG. 2 and FIG. 3, the array substrate further includes a base substrate (not illustrated), where the first gate line Gate1 is located between two adjacent rows of sub-pixel elements 1, and the orthographic projection of the second gate line Gate2 on the base substrate overlaps with the orthographic projections of the pixel electrodes 10 on the base substrate. In this way, the N-type thin film transistors and the P-type thin film transistors can be arranged in parallel, and can be charged uniformly to positive and negative voltage more rapidly, that is, the pixel electrodes can be fully charged within a shorter period, so more pixels can be charged at the same refresh frequency, that is, the resolution in the column direction can be improved to thereby improve the display resolution.

In some embodiments of the disclosure, in the array substrate above, as illustrated in FIG. 2 and FIG. 3, for each row of sub-pixel elements 1, the first thin film transistors 11 and the second thin film transistors 12 are located between the first gate line Gate1 and the second gate line Gate2.

Furthermore in a specific implementation, in the array substrate above according to the embodiment of the disclosure, as illustrated in FIG. 2 and FIG. 3, the first thin film transistors 11 and the second thin film transistors 12 are arranged in parallel in the column direction. In this way, the respective thin film transistors in the same sub-pixel element are arranged in parallel connection so that the sub-pixel element is charged by inputting a scan signal to the respective gate lines concurrently to turn on the respective thin film transistors concurrently, and the data line outputs a data voltage to the pixel electrode, so that the same pixel electrode can be charged by at least two thin film transistors to thereby improve the charging efficiency for the pixel electrode.

In a specific implementation, as shown in FIG. 2 and FIG. 3, since a capacitor Cgp1 may be formed between the first gate line Gate1 and each pixel electrode 10, and a capacitor Cgp2 may be formed between the second gate line Gate2 and the pixel electrode 10, and since the distance between the first gate line Gate1 and the pixel electrode 10 is longer than the distance between the second gate line Gate2 and the pixel electrode 10, Cgp2>Cgp1, thus increasing a load on the second gate line Gate2, and also increasing the coupling thereof with the pixel electrode 10. In order to lower the capacitor Cgp2 between the second gate line Gate2 and the pixel electrode 10 to thereby make Cgp1 equal to Cgp2 as much as possible so as to lower the load on the second gate line Gate2. In some embodiments of the disclosure, in the array substrate above, as illustrated in FIG. 4 and FIG. 5, for each row of sub-pixel elements 1, the first gate line Gate1 and the second gate line Gate2 are located on the same side of the row of sub-pixel elements 1, so that the N-type thin film transistors and the P-type thin film transistors can be arranged in parallel, and can be charged uniformly to positive and negative voltage more rapidly, that is, the pixel electrodes can be fully charged within a shorter period, so more pixels can be charged at the same refresh frequency, that is, the resolution in the column direction can be improved to thereby improve the display resolution. Furthermore the first gate line Gate1 and the second gate line Gate2 corresponding to each row of sub-pixel elements 1 are arranged adjacent to each other, and the first thin film transistors 11 and the second thin film transistors 12 are located on the sides of the first gate line Gate1 and the second gate line Gate2 toward to the pixel electrodes 10, and between the first and second gate lines Gate1, Gate2, and the pixel electrodes 10, so that the distance between the first gate line Gate1 and the pixel electrode 10 is substantially equal to the distance between the second gate line Gate2 and the pixel electrode 10, thus making Cgp1 substantially equal to Cgp2. Since the signals on the first gate line Gate1 and the second gate line Gate2 are opposite in phase at the same instance of time, there is opposite coupling of the first gate line Gate1 and the second gate line Gate2 with the pixel electrode 10 to thereby cancel off their coupling.

In some embodiments of the disclosure, in the array substrate above, as illustrated in FIG. 4, FIG. 5, FIG. 6, and FIG. 7, the array substrate further includes a base substrate (not illustrated), and the orthographic projection of each of the first gates and .second gate lines on the base substrate has no overlapping with orthographic projections of the pixel electrodes on the base substrate.

In some embodiments of the disclosure, in the array substrate above, as illustrated in FIG. 4 and FIG. 5, the first thin film transistors 11 and the second thin film transistors 12 are arranged in parallel in the row direction. In this way, the respective thin film transistors in the same sub-pixel element are arranged in parallel so that the sub-pixel element is charged by inputting a scan signal to the respective gate lines concurrently to turn on the respective thin film transistors concurrently, and data lines output data voltages to the pixel electrodes, so that the same pixel electrode can be charged by at least two thin film transistors to thereby improve the charging efficiency for the pixel electrode.

In some embodiments of the disclosure, in the array substrate above, as illustrated in FIG. 6 and FIG. 7, for each row of sub-pixel elements 1, the first gate line Gate1 and the second gate line Gate2 are located respectively on two sides of the row of sub-pixel elements 1. Since the signals on the first gate line Gate1 and the second gate line Gate2 are opposite in phase at the same instance of time, there is opposite coupling of the first gate line Gate1 and the second gate line Gate2 with the pixel electrode 10 to thereby cancel off their coupling. Furthermore the N-type thin film transistors and the P-type thin film transistors are arranged in parallel, and charged uniformly to positive and negative voltage more rapidly, that is, the pixel electrodes are fully charged within a shorter period, so more pixels can be charged at the same refresh frequency, that is, the resolution in the row direction can be improved to thereby improve the display resolution.

In some embodiments of the disclosure, in the array substrate above, as illustrated in FIG. 6 and FIG. 7, the first thin film transistor 11 is located on the side of the pixel electrode 10 proximate to the first gate line Gate1, and the second thin film transistor 12 is located on the side of the pixel electrode 10 proximate to the second gate line Gate2.

Based upon the same idea, an embodiment of the disclosure further provides a display panel including the array substrate above according to the embodiment of the disclosure. The display panel addresses the problem under a similar principle to the array substrate above, so reference can be made to the implementation of the array substrate above for an implementation of the display panel, and a repeated description thereof will be omitted here.

In a specific implementation, in the display panel above according to the embodiment of the disclosure, the display panel is a liquid crystal display panel.

Based upon the same idea, an embodiment of the disclosure further provides a display device including the display panel above according to the embodiment of the disclosure. The display device addresses the problem under a similar principle to the display panel above, so reference can be made to the implementation of the display panel above for an implementation of the display device, and a repeated description thereof will be omitted here.

In a specific implementation, the display device according to the embodiment of the disclosure can be a mobile phone, a tablet computer, a TV set, a display, a notebook computer, a digital photo frame, a navigator, or any other product or component with a display function. All the other components indispensable to the display device shall readily occur to those ordinarily skilled in the art, so a repeated description thereof will be omitted here, and the embodiment of the disclosure will not be limited thereto. Reference can be made to the embodiment of the display panel above for an implementation of the display device, so a repeated description thereof will be omitted here.

In the array substrate, the display panel, and the display device according to the embodiments of the disclosure, at least one first thin film transistor and at least one second thin film transistor are arranged in each sub-pixel element of the array substrate to be electrically connected with pixel electrode, and gates of the plurality of thin film transistors are connected with different gate lines, that is, the plurality of thin film transistors in the same sub-pixel element are arranged in parallel. In this way, the sub-pixel element is charged by inputting a scan signal to the gate lines concurrently to turn on the plurality of thin film transistors concurrently, and the data line output a data voltage to the pixel electrode, so that the same pixel electrode can be charged by at least two thin film transistors to thereby improve the charging efficiency for the pixel electrode.

Evidently those skilled in the art can make various modifications and variations to the disclosure without departing from the spirit and scope of the disclosure. Thus the disclosure is also intended to encompass these modifications and variations thereto so long as the modifications and variations come into the scope of the claims appended to the disclosure and their equivalents.

1. An array substrate, comprising: a plurality of first gate lines, a plurality of second gate lines, a plurality of data lines, and a plurality of sub-pixel elements in an array, wherein each row of the sub-pixel elements is connected with one of the first gate lines and one of the second gate lines, and each column of the sub-pixel elements is connected with one of the data lines; and
each of the sub-pixel elements comprises: a pixel electrode, at least one first thin film transistor, and at least one second thin film transistor; and in each of the sub-pixel elements in each row, the first thin film transistor has a gate connected with the first gate line corresponding to the row, a first electrode connected with the corresponding data line, and a second electrode connected with the pixel electrode; and the second thin film transistor has a gate connected with the second gate line corresponding to the row, a first electrode connected with a corresponding data line, and a second electrode connected with the pixel electrode.

2. The array substrate according to claim 1, wherein the first gate line and the second gate line, and the first thin film transistor and the second thin film transistor are configured to improve charging efficiency of the sub-pixel elements.

3. The array substrate according to claim 1, wherein the first thin film transistor and the second thin film transistor are opposite types of thin film transistors.

4. The array substrate according to claim 3, wherein the first thin film transistor is an N-type thin film transistor, and the second thin film transistor is a P-type thin film transistor; or the first thin film transistor is a P-type thin film transistor, and the second thin film transistor is an N-type thin film transistor.

5. The array substrate according to claim 3, further comprising: an inverter connected between the first gate line and the second gate line corresponding to each row of sub-pixel elements.

6. The array substrate according to claim 5, further comprising: a gate driver circuit connected with the first gate line, wherein the gate driver circuit is configured to output a signal to the first gate line, the inverter inverts the signal on the first gate line and outputs to the second gate line, to control the first thin film transistors and the second thin film transistors to be turned on concurrently.

7. The array substrate according to claim 5, further comprising: a gate driver circuit connected with the second gate line, wherein the gate driver circuit is configured to output a signal to the second gate line, the inverter inverts the signal on the second gate line and outputs to the first gate line, to control the first thin film transistors and the second thin film transistors to be turned on concurrently.

8. The array substrate according to claim 3, further comprising: a first gate driver circuit connected with the first gate lines, and a second gate driver circuit connected with the second gate lines, wherein for the first gate line and the second gate line corresponding to a same row of sub-pixel elements, a signal output by the first gate driver circuit to the first gate line is opposite in phase to a signal output by the second gate driver circuit to the second gate line at a same instance of time.

9. The array substrate according to claim 1, further comprising: a base substrate, wherein each of the first gate lines is located between two adjacent rows of the sub-pixel elements, and an orthographic projection of each of the second gate lines on the base substrate overlaps with orthographic projections of pixel electrodes on the base substrate.

10. The array substrate according to claim 9, wherein for each row of the sub-pixel elements, the first thin film transistors and the second thin film transistors are located between the first gate line and the second gate line.

11. The array substrate according to claim 10, wherein the first thin film transistors and the second thin film transistors are arranged in parallel in a column direction.

12. The array substrate according to claim 1, further comprising: a base substrate, wherein an orthographic projection of each of the first gates and second gate lines on the base substrate has no overlapping with orthographic projections of the pixel electrodes on the base substrate.

13. The array substrate according to claim 12, wherein for each row of the sub-pixel elements, the first gate line and the second gate line are located on a same side of the row of sub-pixel elements.

14. The array substrate according to claim 13, wherein the first gate line and the second gate line are arranged adjacent to each other, and the first thin film transistors and the second thin film transistors are located on sides of the first and the second gate lines toward to the pixel electrodes, and between the first and the second gate lines, and the pixel electrodes.

15. The array substrate according to claim 14, wherein the first thin film transistors and the second thin film transistors are arranged in parallel in a row direction.

16. The array substrate according to claim 12, wherein for each row of the sub-pixel elements, the first gate line and the second gate line are located respectively on two sides of the row of sub-pixel elements.

17. The array substrate according to claim 16, wherein the first thin film transistor is located on a side of the pixel electrode proximate to the first gate line, and the second thin film transistor is located on a side of the pixel electrode proximate to the second gate line.

18. A display panel, comprising the array substrate according to claim 1.

19. A display device, comprising the display panel according to claim 18.
